(19) United States
(12) Patent Application Publication
(10) Pub. No.: US 2015/0011284 A1
(43) Pub. Date: Jan. 8, 2015

(54) CHESS GAME USING SPECIALIZED DICE

(71) Applicant: Peter Costa, Las Vegas, NV (US)

(72) Inventor: Peter Costa, Las Vegas, NV (US)

(21) Appl. No.: 14/323,166

(22) Filed: Jul. 3, 2014

Related U.S. Application Data
(60) Provisional application No. 61/842,860, filed on Jul. 3, 2013.

(51) Int. Cl. A63F 13/822; A63F 3/02

(52) U.S. Cl. CPC A63F 13/822; A63F 3/02
USPC 463/14

(57) ABSTRACT

A method of playing a game where two players use a checkered game board, three specialized dice, and traditional chess pieces. More specifically, the checkered game board can be a traditional eight-by-eight chessboard, or it can be an expanded ten-by-ten board. Additionally, the three specialized dice each display one traditional chess piece per side of the die. Therefore, each die will have one king, one queen, one rook, one knight, one bishop, and one pawn depicted on it. In its most basic sense, the game involves making movements each turn based on the depictions that show ‘up’ when the three dice are rolled.

### CROSS-REFERENCE TO RELATED APPLICATIONS

This application claims the benefit of U.S. Provisional Application No. 61/842,860, filed Jul. 3, 2013, titled CHESS GAME USING SPECIALIZED DICE.

### FIELD OF THE DISCLOSURE

The present invention generally relates to the field of board games. More specifically, it relates to a new game that uses a checkered game board; three dice, with each die depicting all six chess pieces (one per side); traditional chess pieces; and a set of rules.

### BACKGROUND OF THE INVENTION

Chess is traditionally played using an eight-by-eight chessboard with 64 squares and 16 chess pieces per player, with each chess piece being limited to specific moves based on the type of chess piece it is. Each player has six total types of chess pieces: one king, one queen, two rooks, two knights, two bishops, and eight pawns.

### SUMMARY OF THE INVENTION

The present invention relates to a game for two players and requires the use of a chess set and a set of special dice as described herein. The dice help to create a unique and simple format for playing chess. Rolls of the three special dice govern all game moves. The specially designed dice depict the six different chessmen that are used in standard chess. This brings in the important element of chance and a whole new dimension to the battle on a chessboard.

The disclosed game is not standard chess. It's a game that requires a different approach and a completely new strategy. A player may use existing skills and knowledge of chess to help master the strategy of the game described herein. While the game of chess usually requires knowledge of strategy and innate mathematical skills, the disclosed game is more user-friendly. All that a user needs is a basic knowledge of the standard chess moves.

The disclosed game has simple odds and probability that guides players. The special dice provide an equalizing aspect that can destroy any opponent in a single roll. This helps to even the playing field between experienced and inexperienced players. As well as governing all game moves, the special dice allow an extra dimension to the game created by ‘Bonus Rolls.’

The combination of a standard chess set and a set of specially designed dice creates a completely new game for a player's chessboard and men. The simplicity of the game opens up a new approach and strategy to an already existing concept. Gameplay can vary dramatically. However, regular play will alert players to the basic strategy that should be applied.

### BRIEF DESCRIPTION OF THE DRAWINGS

FIG. 1 illustrates an example user interface according to one embodiment of the presently described game.

FIG. 2 illustrates an example user interface according to one embodiment of the presently described game.

FIG. 3 illustrates an example user interface according to one embodiment of the presently described game.

FIG. 4 is a schematic block diagram of an example computing system that may be used in accordance with one embodiment of the presently described game.

FIG. 5 is a schematic block diagram of an example computing system that may be used in accordance with one embodiment of the presently described game.

### DETAILED DESCRIPTION

### Version One

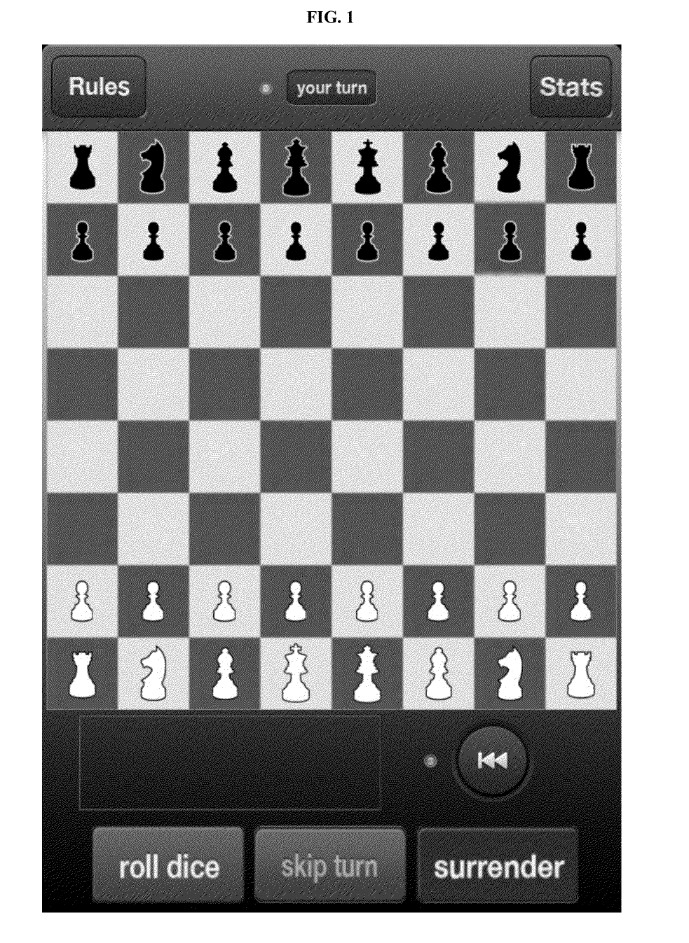

The game is played using the standard rules of chess unless otherwise stated, and all moves must be legal chess moves. In some embodiments, the game can be played using physical chess pieces and dice, as described in more detail below. In some embodiments, the game can be played on one or more computing devices, as described in more detail below. In some examples, when the game is played on computing devices, the computing devices generate visual representations of physical chess pieces, dice, and other components described herein. The visual representations are, for example, displayed on a display device, such as a computer monitor. FIG. 1 through FIG. 3 are example graphical user interfaces that may be displayed to a player when playing the game using a mobile device, for example, a smart phone or tablet device.

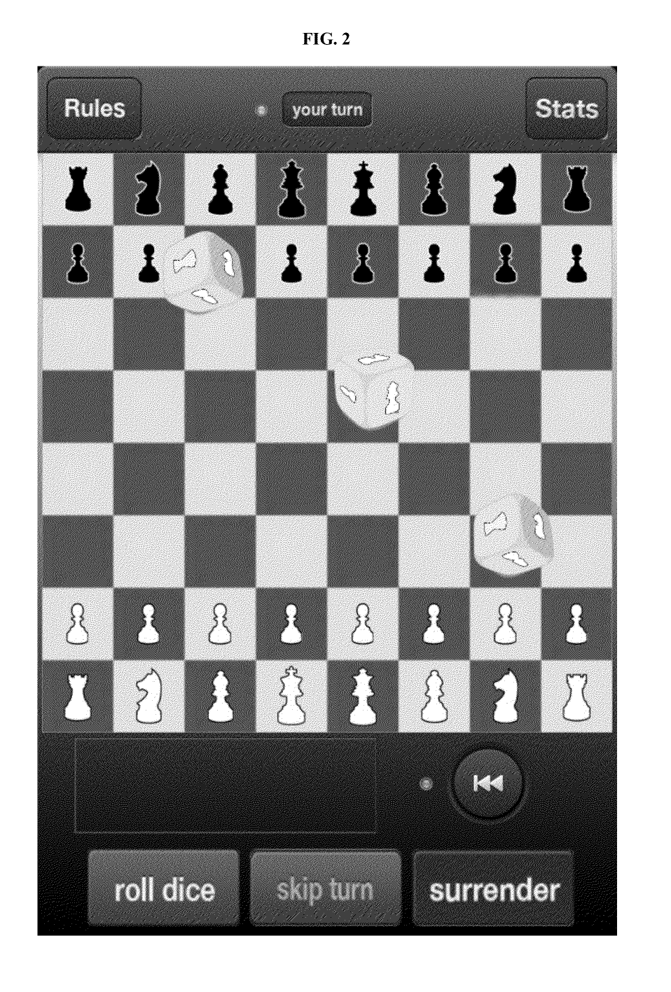

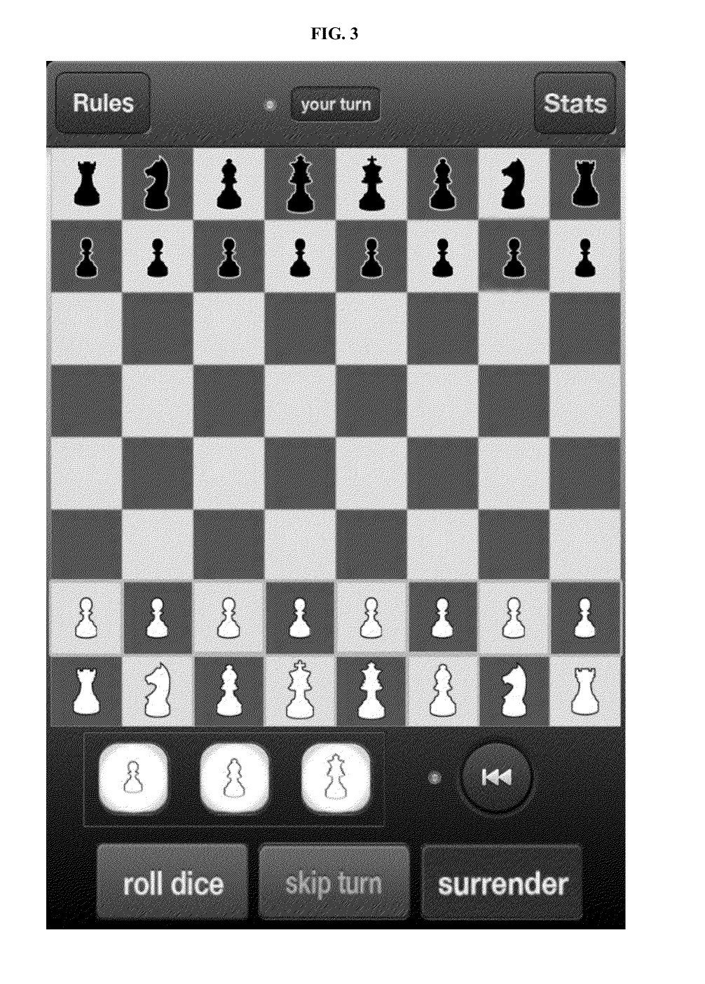

Each player has three similar dice. Each die depicts all six chess pieces, one chess piece per side, examples of which are illustrated in FIG. 2 and FIG. 3. The players take turns to roll all three dice.

A player may move any one of the pieces that are showing ‘up’ on any of the three dice. However, there will be occasions when no move is possible. Also, a player may decline to move on any turn and pass the dice.

If the player throws two dice showing the same piece ‘up’ (a ‘pair’) and one other piece ‘up’, then the player may either move the paired piece, and then immediately roll all three dice and play again ('bonus roll'), or he may elect to move the other unpaired piece to complete the turn.

If the player throws all three dice showing the same piece ‘up’ (a ‘trio’), the player may choose any of the player's active pieces on the board and move it, then roll all three dice and play again.

When a player rolls a ‘pair’ or a ‘trio’ after a pair or a trio, then the player may continue to play again.

If a player uses a ‘pair’ or a ‘trio’ to place an opponent in Check, then the player still continues to roll and play again, and may attack with further pieces, or even remove the Check.

### Free Move Rule & ‘Dicing Out’

If this is one of the first two times the player has placed his opponent in Check within a game, the opponent is allowed to make a ‘Free Move’ to attempt to escape the Check without having to throw the dice.

After the first two times the player has placed his opponent in Check within a game, the opponent is now in danger of losing the game and being ‘Diced Out’ as described below.

An opponent in Check for the third time or more is allowed up to three immediate consecutive rolls of the dice to escape from Check, otherwise the player is ‘Diced Out’ and the game is lost.

During these three rolls, the player may only make a move that will immediately remove the Check. Any successful escape from Check completes the move. A successful escape that is the result of using a ‘pair’ or a ‘trio’ does allow the escaping player to continue with a ‘Bonus Roll’.

### Winning the Game

A player can win the game under the following circumstances: (1) placing the opponent in Checkmate; (2) forcing the opponent to resign; (3) win by ‘Attrition,’ wherein the opponent has only the king remaining; (4) ‘Diced Out,’ wherein the opponent fails to escape Check within the allowed three rolls of the dice.

There is a very slim possibility of a stalemate, and players may agree to a draw at any time. The fifty-move rule, castling, the en-passant rule, and the three-move repetition rule sometimes used in standard chess games do not apply.

Promoting a pawn to any other piece when it reaches the 8th rank is allowed.

### Game Tips & Strategy

The simple strategy of the game described herein is based on the near even chance (42% or 1.37-1) probability of rolling any one desired piece.

Players must try to avoid the loss of both pieces that are of equal value (i.e. Bishops, Rooks and Knights). The loss of any such set will restrict the options to move and limit the opportunity to gain ‘Bonus Rolls’. As there is only a single Queen, players are advised to use discretion by not placing her at obvious risk. Having Pawns to spare allows them to become unusually powerful pieces.

### ‘Dicing Out’ Your Opponents

Aggressive players may look to place their opponents in Check early in the game to ensure that their opponents quickly use their two ‘Free Moves.’ After the first two Checks have been used, the opportunity to ‘Dice Out’ an opponent for a quick, but somewhat lucky, win presents itself

‘Dicing Out’ can be a dangerous strategy, as the odds of the opponent escaping by using one of the three rolls of the dice will dramatically favor the escape. The opponent could get lucky and role a ‘pair’ or ‘trio’ and turn a defense into an attack. ‘Dicing Out’ is a strategy that can be adopted more frequently in desperate situations, where desperate measures are called for.

### Mathematical Odds and Probabilities

The following mathematical odds and probabilities exist according to one embodiment of the game: rolling at least one desired piece=1.37 to 1; failure to roll one desired piece=0.07 to 1 or 4 to 6; rolling any pair=7 to 5; rolling three of a kind=35 to 1; escape from a Check=0.24 to 1 or Approx. 4 to 1 ON; (Using one of the three allowable rolls to stop becoming ‘Diced Out’); failure to escape from Check and becoming ‘Diced Out’=4.16 to 1

### Version Two

In this version, a board of 10×10 squares replaces the standard chessboard of 8×8 squares. This allows for extra chess pieces to be introduced. In the first version, only having one queen can restrict moves and limit strategy. In this example therefore, an extra queen will be introduced.

This version will see certain pieces begin the game in advanced positions to ensure that all pieces are able to move from the very first roll of the dice. In the first version, only the pawns and knights are able to move.

One option in regards to the extra queen is to restrict its possible moves until the other queen is lost. For example, in one embodiment, the game can allocate the first vertical line on the board (left of the board) as the extra queen's sole pathway unless an opposing piece is able to take that queen. The queen's pathway will be allocated a different color than the other squares on the board. Neither black nor white—for example, striped.

The extra squares will also play a major role by creating extra spaces and a different strategy. For example, the advanced pawns feature would see both end pawns advanced three squares. In effect, opposition pawns will meet (and be unable to move at this stage). By advancing the pawn that releases both the queen and the bishop, all pieces will be able to move from the very first roll.

Overall, these features allow for more experimentation and versions to be created.

### Version Three

By offering a pre-determined number of dice rolls (for example, five or six), players can apply pure skill to strategy rather than random dice rolls.

In one embodiment, five different random dice rolls, with each roll having three dice, are provided at the start of the game. In this case, one dice roll would consist of three specialized dice, each showing the possible pieces that a player can move.

Players can take turns choosing one the five rolls. When each player has played two turns, only dice roll would be available. Therefore, a further four dice rolls could occur, once again providing five options of three dice. This will continue until a winner is determined.

Different options are available in terms of when dice rolls are added. In the above example, four dice rolls are added when down to one dice roll. It may be more suitable to the game if three more dice rolls are added when there are two remaining dice rolls.

Another option is to simply add five new dice rolls when the first five have been played. In effect, all the figures/numbers used in the examples could be increased or reduced to suit the game.

### Version Four

By allocating a points value to each chess piece or check or even bonus roll, a new strategy can be applied to the disclosed game. This could be a combination of one or more of the above versions. Irrespective, by introducing a points version, games can be set to a limited number of turns or rolls from each player. For example, games can be limited to ten, fifteen, or twenty or more turns or rolls.

A doubling cube, as used in backgammon, can also be introduced to any or all the versions. Irrespective, the doubling cube will bring an increased element to the game.

### Technical Components

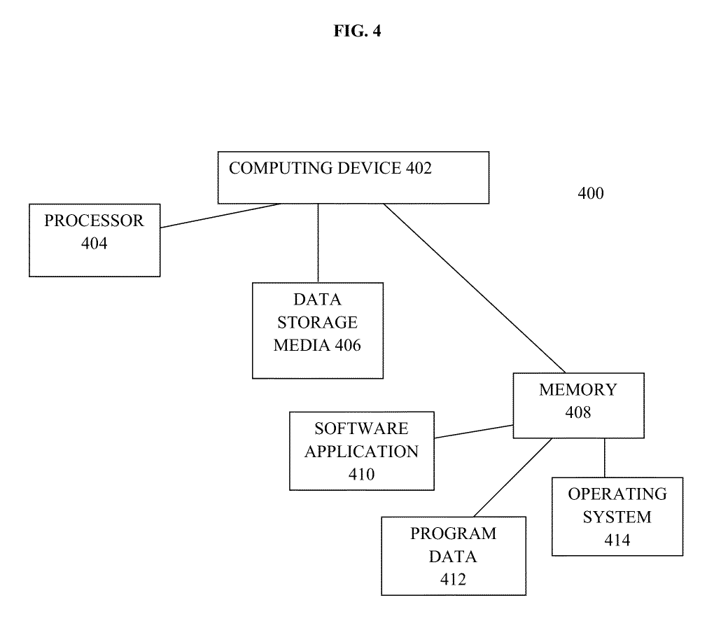

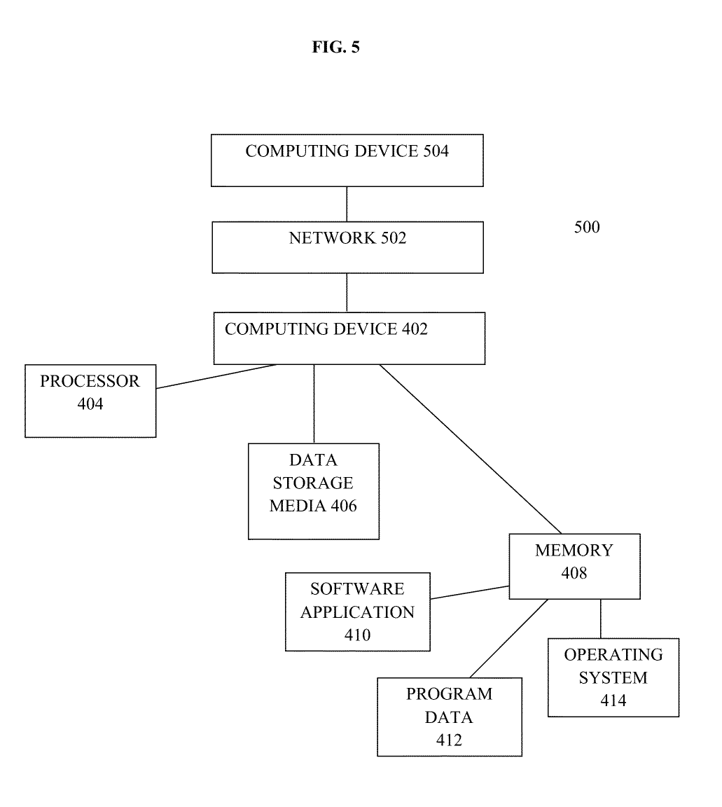

In some embodiments, the disclosed game is played using a computing system. FIG. 4 is a schematic block diagram of an example computing system 400. The computing system 400 includes at least one computing device 402. FIG. 5 is a schematic block diagram of an example computing system 500 that further includes a communication network 502 and one or more additional computing devices 504 (such as a server).

Computing device 402 can be, for example, located in a place of business or can be a computing device located in a player's home or office. In some embodiments, computing device 402 is a mobile device, for example, a smart phone or tablet device. In some embodiments, computing device 402 is a gaming machine. Computing device 402 can be a stand-alone computing device or a networked computing device that communicates with one or more other computing devices 504 across a network 502. The additional computing device(s) 504 can be, for example, located remotely from the first computing device 402, but configured for data communication with the first computing device 402 across a network 502.

In some examples, the computing devices 402 and 504 include at least one processor or processing unit 404 and system memory 408. The processor 404 is a device configured to process a set of instructions. In some embodiments, system memory 408 may be a component of processor 404; in other embodiments system memory is separate from the processor. Depending on the exact configuration and type of computing device, the system memory 408 may be volatile (such as RAM), non-volatile (such as ROM, flash memory, etc.) or some combination of the two. System memory 408 typically includes an operating system 414 suitable for controlling the operation of the computing device, such as the Linux operating system. The system memory 408 may also include one or more software applications 410 and may include program data 412.

One or more of the computing devices 402, 504 may have additional features or functionality. For example, the devices 402, 504 may also include additional data storage devices 406 (removable and/or non-removable) such as, for example, magnetic disks, optical disks, or tape. Computer storage media 406 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 406 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by one or more of the computing devices 402, 504. An example of computer storage media 406 is non-transitory media.

In some examples, one or more of the computing devices 402, 504 can be located in a player's home or place of business. In other examples, one or more of the computing devices 402, 504 can be a personal computing device that is networked to allow the user to access the disclosed system at a remote location, such as in a user's home, office or other location. In some embodiments, the computing device 402 is a smart phone, tablet, laptop computer, personal digital assistant, or other mobile computing device. In some embodiments the invention is stored as data instructions for a smart phone application or a tablet application. A network 502 can facilitate communication between the computing device 402 and one or more servers, such as an additional computing device 504, that host the system. The network 502 may be a wide variety of different types of electronic communication networks. For example, the network 502 may be a wide-area network, such as the Internet, a local-area network, a metropolitan-area network, or another type of electronic communication network. The network 502 may include wired and/or wireless data links. A variety of communications protocols may be used in the network 502 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 504 is a Web server. In this example, the first computing device 402 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 402, 504, the instructions cause the processor to perform one or more of the operations or methods disclosed herein.

We claim:

1. A method of operating a computing device for playing a game comprising:
providing a computing device;
providing a non-transitory computer readable medium encoded with instructions and executed by a processor to perform the steps of:
causing at least one processor to execute a plurality of instructions stored in at least one memory device to operate with at least one display device to display a checkered game board with two sets of chess pieces, one on each side, and a plurality of specialized dice depicting six different chess pieces on each die's six sides;
causing the at least one processor to execute the plurality of instructions stored in the at least one memory device to operate with at least one input device to receive a request from a first player during the first player's turn for a roll of the plurality of specialized dice;
causing the at least one processor to execute the plurality of instructions stored in the at least one memory device to operate with at least one display device to display the plurality of specialized dice, each with one depicted chess piece facing upward, after the first player's roll;
causing the at least one processor to execute the plurality of instructions stored in the at least one memory device to operate with the at least one input device to receive a request from the first player to move a chess piece on the checkered game board that corresponds to any one of the depicted chess pieces facing upward;
causing the at least one processor to execute the plurality of instructions stored in the at least one memory device to operate with at least one display device to display the movement of the first player's chess piece on the checkered game board;
causing the at least one processor to execute the plurality of instructions stored in the at least one memory device to operate with the at least one input device to receive a request from a second player during the second player's turn for a roll of the plurality of specialized dice;
causing the at least one processor to execute the plurality of instructions stored in the at least one memory device to operate with at least one display device to display the plurality of specialized dice, each with one depicted chess piece facing upward, after the second player's roll;
causing the at least one processor to execute the plurality of instructions stored in the at least one memory device to operate with the at least one input device to receive a request from the second player to move a chess piece on the checkered game board that corresponds to any one of the depicted chess pieces facing upward;
causing the at least one processor to execute the plurality of instructions stored in the at least one memory device to operate with at least one display device to display the movement of the second player's chess piece on the checkered game board;
causing the at least one processor to execute the plurality of instructions stored in the at least one memory device to permit a plurality of turns for the first and the second player, taken in alternate succession;
causing the at least one processor to execute the plurality of instructions stored in the at least one memory device to determine whether the first or second player has won after the plurality of turns when either the first or second player is placed in checkmate, wherein checkmate is determined when a chess piece of the first or second player designated as king is threatened to be captured and there is no valid move to escape the threat;
causing the at least one processor to execute the plurality of instructions stored in the at least one memory device to determine any awards to be provided to either player based on the determination of which player won; and
causing the at least one processor to execute the plurality of instructions stored in the at least one memory device to cause any determined awards to be provided to the winning player.

2. The method of claim 1, wherein either player receives an immediate, extra turn if the player's roll results in two of the dice depicting the same chess piece facing upward and the player moves the corresponding chess piece.

3. The method of claim 1, wherein either player is allowed to move any of the player's active pieces if the player's roll results in three of the dice depicting the same chess piece facing upward.

4. The method of claim 3, wherein the player receives an immediate, extra turn.

5. The method of claim 1, wherein either player is allowed to make one move to escape check when the player has been placed in check by the other player.

6. The method of claim 1, wherein either player is allowed to roll the dice three consecutive times to escape check when the player has been placed in check by the other player.

7. The method of claim 1, wherein the checkered game board is an eight-by-eight game board.

8. The method of claim 1, wherein the checkered game board is a ten-by-ten game board.

9. The method of claim 1, wherein each player plays with one king, one queen, two rooks, two knights, two bishops, and eight pawns.

10. The method of clam 1, wherein each player plays with one king, a first queen, a second queen, two rooks, two knights, two bishops, and eight pawns.

11. The method of claim 10, wherein the second queen is initially limited to movement on the left-most column of the checkered game board.

12. The method of claim 11, wherein the second queen is allowed to move off of the left-most column if an opposing piece can take the second queen.

13. The method of claim 10, wherein the eight pawns can each initially move three spaces.

14. The method of claim 1, wherein five groups of the three specialized dice are rolled at the beginning on the game and each player chooses one group to play with for the player's turn.

15. The method of claim 14, wherein five additional groups of the three specialized dice are rolled after the five groups have been played with.

16. The method of claim 14, wherein four additional groups of the three specialized dice are rolled after four of the five groups have been played with.

17. The method of claim 14, wherein three additional groups of the three specialized dice are rolled after three of the five groups have been played with.

18. The method of claim 1, wherein the number of turns for each player is limited.

19. The method of claim 1, wherein a doubling cube is used.
